(19) United States
(12) Patent Application Publication
(10) Pub. No.: US 2013/0136964 A1
(43) Pub. Date: May 30, 2013

(54) ELECTROCHEMICAL CELL HAVING A SAFETY DEVICE

(71) Applicants: Feng Li, Troy, MI (US); Xugang Zhang, Milwaukee, WI (US)

(72) Inventors: Feng Li, Troy, MI (US); Xugang Zhang, Milwaukee, WI (US)

(73) Assignee: JOHNSON CONTROLS TECHNOLOGY COMPANY, Holland, MI (US)

(21) Appl. No.: 13/631,220

(22) Filed: Sep. 28, 2012

Related U.S. Application Data
(60) Provisional application No. 61/565,200, filed on Nov. 30, 2011.

(51) Int. Cl. H01M 10/50; H01M 6/42

(52) U.S. Cl. 429/62; 429/50; 429/156

(57) ABSTRACT

An electrochemical cell is provided including, but not limited to, a can, an output terminal for outputting current generated within the can, an electrode assembly connected with the output terminal and which comprises a positive electrode and a negative electrode, electrolyte within the can, and a safety device provided within the can. The safety device is configured to interrupt or reduce electric current passing from the electrode assembly to the output terminal when temperature inside the can exceeds a predetermined temperature.

### RELATED APPLICATIONS

The present application is related to and claims benefit under 35 U.S.C. §119(e) from U.S. Provisional Patent Application Ser. No. 61/565,200, entitled, “ELECTROCHEMICAL CELL HAVING A SAFETY DEVICE,” filed Nov. 30, 2011, the entire contents of which are hereby incorporated by reference in their entirety to the extent permitted by law.

### FIELD OF THE DISCLOSURE

The present application relates generally to the field of batteries and battery systems and, more specifically, to batteries and battery systems that may be used in vehicle applications to provide at least a portion of the motive power for a vehicle using electric power.

### BACKGROUND OF THE INVENTION

Vehicles using electric power for all or a portion of their motive power may provide a number of advantages as compared to more traditional gas-powered vehicles using internal combustion engines. For example, vehicles using electric power may produce fewer undesirable emission products and may exhibit greater fuel efficiency as compared to vehicles using internal combustion engines (and, in some cases, such vehicles may eliminate the use of gasoline entirely).

As technology continues to evolve, there is a need to provide improved power sources (e.g., battery systems or modules) for such vehicles. For example, it is desirable to increase the distance that such vehicles may travel without the need to recharge the batteries. It is also desirable to improve the performance of such batteries and to reduce the cost associated with the battery systems.

One area of improvement that continues to develop is in the area of battery chemistry. Early systems for vehicles using electric power employed nickel-metal-hydride (NiMH) batteries as a propulsion source. Over time, different additives and modifications have improved the performance, reliability, and utility of NiMH batteries.

More recently, manufacturers have begun to develop lithium-ion batteries that may be used in vehicles using electric power. There are several advantages associated with using lithium-ion batteries for vehicle applications. For example, lithium-ion batteries have a higher charge density and specific power than NiMH batteries. Stated another way, lithium-ion batteries may be smaller than NiMH batteries while storing the same amount of charge, which may allow for weight and space savings in a vehicle using electric power (or, alternatively, this feature may allow manufacturers to provide a greater amount of power for the vehicle using electric power without increasing the weight of the vehicle using electric power or the space taken up by the battery system).

It is generally known that lithium-ion batteries perform differently than NiMH batteries and may present design and engineering challenges that differ from those presented with NiMH battery technology. For example, lithium-ion batteries may be more susceptible to variations in battery temperature than comparable NiMH batteries, and thus systems may be used to regulate the temperatures of the lithium-ion batteries during vehicle operation. The manufacture of lithium-ion batteries also presents challenges unique to this battery chemistry, and new methods and systems are being developed to address such challenges.

It is also generally known that batteries and battery systems (both lithium-ion and NiMH) are subjected to various environmental and other potentially damaging conditions. For example, battery systems are sometimes provided on the exterior or underside of a vehicle using electric power, subjecting the battery systems to rain, snow, sleet and any other combination of inclement weather. Such battery systems may also be impacted by an object, such as, e.g., during an accident, which may cause a short circuit condition of the battery. Further, abuse of a battery (e.g., a short circuit, or over/under charging) may lead to high temperatures and/or excess pressure within the battery, causing the battery to vent electrolyte contained within the battery.

It would be desirable to provide an improved battery module and/or system for use in vehicles using electric power that addresses one or more challenges associated with NiMH and/or lithium-ion battery systems used in such vehicles. It also would be desirable to provide a battery module and/or system that includes any one or more of the advantageous features that will be apparent from a review of the present disclosure.

### SUMMARY

The present invention is defined by the following claims, and nothing in this section should be taken as a limitation on those claims.

According to one aspect, an electrochemical cell is provided including, but not limited to, a can, an output terminal for outputting current generated within the can, an electrode assembly connected with the output terminal and which comprises a positive electrode and a negative electrode, electrolyte within the can, and a safety device provided within the can. The safety device is configured to interrupt or reduce electric current passing from the electrode assembly to the output terminal when temperature inside the can exceeds a predetermined temperature.

According to one aspect, a method for controlling heat within an electrochemical cell is provided. The electrochemical cell has a can, an output terminal for outputting current generated within the can, an electrode assembly connected with the output terminal and which comprises a positive electrode and a negative electrode, electrolyte within the can, and a safety device provided within the can. The method includes, but is not limited to, interrupting or reducing the amount of electric current passing from the electrode assembly to the output terminal using the safety device, when temperature inside the can exceeds a predetermined temperature.

According to one aspect a battery system is provided. The system includes, but is not limited to, a plurality of electrochemical cells. Each electrochemical cell includes a can, an output terminal for outputting current generated within the can, an electrode assembly connected with the output terminal and which comprises a positive electrode and a negative electrode, electrolyte within the can, and a safety device provided within the can. The safety device is positioned between and electrically connected with the electrode assembly and the output terminal. The safety device is configured to interrupt or reduce the amount of electric current passing from the electrode assembly to the output terminal when temperature inside the can exceeds a predetermined temperature.

### BRIEF DESCRIPTION OF THE DRAWINGS

The invention can be better understood with reference to the following drawings and description. The components in the figures are not necessarily to scale, emphasis instead being placed upon illustrating the principles of the invention.

FIG. 1 is a perspective view of a vehicle including a battery system according to an exemplary embodiment.

FIG. 2 is a cutaway schematic view of a vehicle including a battery system according to an exemplary embodiment.

FIG. 3 is a partial cutaway view of a battery system according to an exemplary embodiment.

FIG. 4 is another partial cutaway view of the battery system of FIG. 3 according to an exemplary embodiment.

FIG. 5 is a perspective view of a cylindrical cell according to an exemplary embodiment.

FIG. 6 is a cross-sectional view of an electrochemical cell of FIG. 5 having a safety device according to an embodiment.

FIG. 7 is a perspective view of a prismatic cell according to another exemplary embodiment.

FIG. 8 is a cross-sectional view of an electrochemical cell of FIG. 7 having a safety device according to another exemplary embodiment.

FIG. 9 is a cross-sectional view of an electrochemical cell which electrodes are stacked and PTC films are inserted within, according to yet another exemplary embodiment.

FIG. 10 is a cross-sectional view of an electrochemical cell which electrodes are wrapped around a mandrel and PTC films are inserted within, according to yet another exemplary embodiment.

### DETAILED DESCRIPTION

FIG. 1 is a perspective view of a vehicle 10 in the form of an automobile (e.g., a car) having a battery system 20 for providing all or a portion of the motive power for the vehicle 10.

For the purposes of the present disclosure, it should be noted that the battery modules and systems illustrated and described herein are particularly directed to applications in providing and/or storing energy in xEV electric vehicles. As will be appreciated by those skilled in the art, hybrid electric vehicles (HEVs) combine an internal combustion engine propulsion and high voltage battery power to create traction, and includes mild hybrid, medium hybrid, and full hybrid designs. A plug-in electric vehicle (PEV) is any vehicle that can be charged from an external source of electricity, such as wall sockets, and the energy stored in the rechargeable battery packs drives or contributes to drive the wheels. PEVs are a subcategory of vehicles using electric power for propulsion that include all-electric (EV) or battery electric vehicles (BEVs), plug-in hybrid vehicles (PHEVs), and electric vehicle conversions of hybrid electric vehicles and conventional internal combustion engine vehicles. The term “xEV” is defined herein to include all of the foregoing or any variations or combinations thereof that include electric power as a motive force. Additionally, although illustrated as a car in FIG. 1, the type of the vehicle 10 may be implementation-specific, and, accordingly, may differ in other embodiments, all of which are intended to fall within the scope of the present disclosure. For example, the vehicle 10 may be a truck, bus, industrial vehicle, motorcycle, recreational vehicle, boat, or any other type of vehicle that may benefit from the use of electric power for all or a portion of its propulsion power.

For the purposes of the present disclosure, it should be also noted that the battery modules and systems illustrated and described herein are also particularly directed to applications in providing and/or storing energy in stand-by power units which may be used to provide power for residential homes or businesses which typically rely on power provided from an electrical grid. A stand-by power unit can provide power which may be used as a substitute for power provided from an electrical grid, for any building or device which typically relies on power provided from an electrical grid, such as a residential home or business.

Although the vehicle 10 is illustrated as a car in FIG. 1, the type of vehicle may differ according to other exemplary embodiments, all of which are intended to fall within the scope of the present disclosure. For example, the vehicle 10 may be a truck, bus, industrial vehicle, motorcycle, recreational vehicle, boat, or any other type of vehicle that may benefit from the use of electric power for all or a portion of its propulsion power.

Although the battery system 20 is illustrated in FIG. 1 as being positioned in the trunk or rear of the vehicle, according to other exemplary embodiments, the location of the battery system 20 may differ. For example, the position of the battery system 20 may be selected based on the available space within a vehicle, the desired weight balance of the vehicle, the location of other components used with the battery system 20 (e.g., battery management systems, vents, or cooling devices, etc.), and a variety of other consideration.

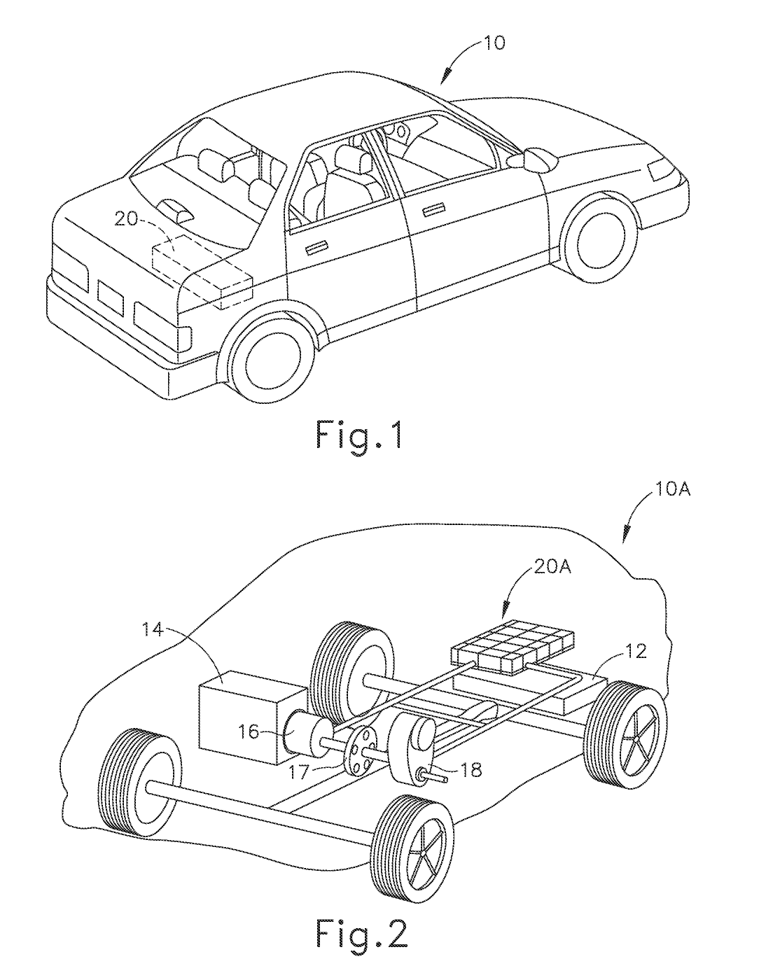

FIG. 2 illustrates a cutaway schematic view of a vehicle 10A provided in the form of an HEV according to an exemplary embodiment. A battery system 20A is provided toward the rear of the vehicle 10A proximate a fuel tank 12 (the battery system 20A may be provided immediately adjacent the fuel tank 12 or may be provided in a separate compartment in the rear of the vehicle 10A (e.g., a trunk) or may be provided elsewhere in the vehicle 10A). An internal combustion engine 14 is provided for times when the vehicle 10A utilizes gasoline power to propel the vehicle 10A. An electric motor 16, a power split device 17, and a generator 18 are also provided as part of the vehicle drive system.

Such a vehicle 10A may be powered or driven by just the battery system 20A, by just the engine 14, or by both the battery system 20A and the engine 14. It should be noted that other types of vehicles and configurations for the vehicle drive system may be used according to other exemplary embodiments, and that the schematic illustration of FIG. 2 should not be considered to limit the scope of the subject matter described in the present application.

According to various exemplary embodiments, the size, shape, and location of the battery systems 20, 20A, the type of vehicles 10, 10A, the type of vehicle technology (e.g., HEV, PEV, EV BEV, PHEV, xEV, etc.), and the battery chemistry, among other features, may differ from those shown or described.

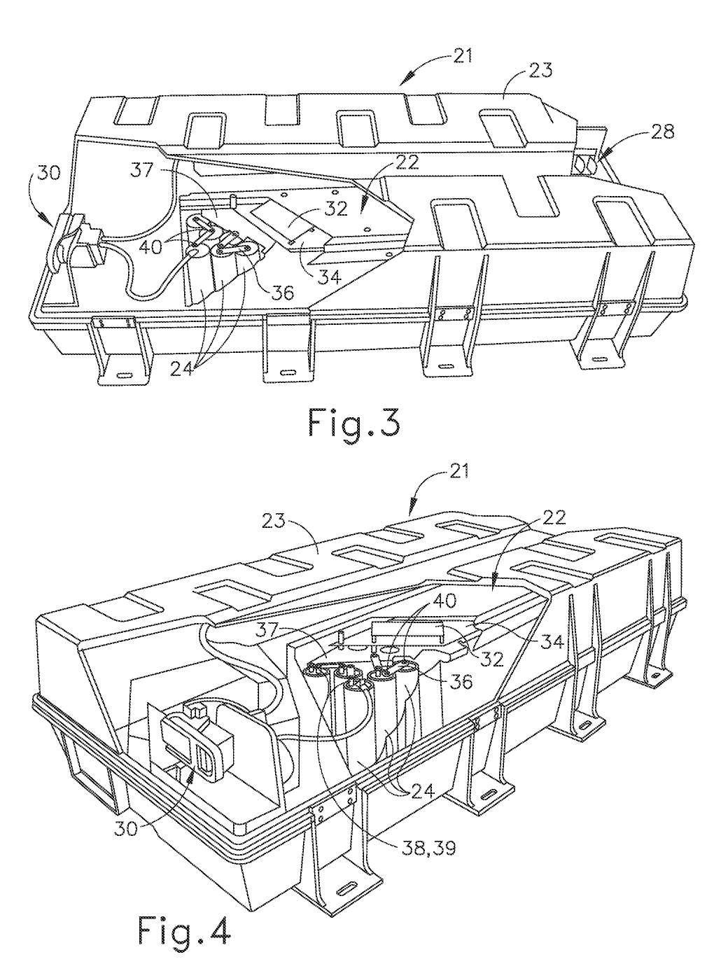

Referring now to FIGS. 3-4, partial cutaway views of a battery system 21 are shown according to an exemplary embodiment. According to an exemplary embodiment, the battery system 21 is responsible for packaging or containing electrochemical batteries or cells 24, connecting the electrochemical cells 24 to each other and/or to other components of the vehicle electrical system, and regulating the electrochemical cells 24 and other features of the battery system 21. For example, the battery system 21 may include features that are responsible for monitoring and controlling the electrical performance of the battery system 21, managing the thermal behavior of the battery system 21, containing and/or routing of effluent (e.g., gases that may be vented from a cell 24), and other aspects of the battery system 21.

According to the exemplary embodiment as shown in FIGS. 3-4, the battery system 21 includes a cover or housing 23 that encloses the components of the battery system 21. Included in the battery system are two battery modules 22 located side-by-side inside the housing 23. According to other exemplary embodiments, a different number of battery modules 22 may be included in the battery system 21, depending on the desired power and other characteristics of the battery system 21. According to other exemplary embodiments, the battery modules 22 may be located in a configuration other than side-by-side (e.g., end-to-end, etc.).

As shown in FIGS. 3-4, the battery system 21 also includes a high voltage connector 28 located at one end of the battery system 21 and a service disconnect 30 located at a second end of the battery system 21 opposite the first end according to an exemplary embodiment. The high voltage connector 28 connects the battery system 21 to a vehicle 10. The service disconnect 30, when actuated by a user, disconnects the two individual battery modules 22 from one another, thus lowering the overall voltage potential of the battery system 21 by half to allow the user to service the battery system 21.

According to an exemplary embodiment, each battery module 22 includes a plurality of cell supervisory controllers (CSCs) 32 to monitor and regulate the electrochemical cells 24 as needed. According to other various exemplary embodiments, the number of CSCs 32 may differ. The CSCs 32 are mounted on a member shown as a trace board 34 (e.g., a printed circuit board). The trace board 34 includes the necessary wiring to connect the CSCs 32 to the individual electrochemical cells 24 and to connect the CSCs 32 to the battery management system (not shown) of the battery system 21. The trace board 34 also includes various connectors to make these connections possible (e.g., temperature connectors, electrical connectors, voltage connectors, etc.).

Still referring to FIGS. 3-4, each of the battery modules 22 includes a plurality of electrochemical cells 24 (e.g., lithium-ion cells, nickel-metal-hydride cells, lithium polymer cells, etc., or other types of electrochemical cells now known or hereafter developed). According to an exemplary embodiment, the electrochemical cells 24 are generally cylindrical lithium-ion cells configured to store an electrical charge. According to other exemplary embodiments, the electrochemical cells 24 could have other physical configurations (e.g., oval, prismatic, polygonal, etc.). The capacity, size, design, and other features of the electrochemical cells 24 may also differ from those shown according to other exemplary embodiments.

Each of the electrochemical cells 24 are electrically coupled to one or more other electrochemical cells 24 or other components of the battery system 21 using connectors provided in the form of bus bars 36 or similar elements. According to an exemplary embodiment, the bus bars 36 are housed or contained in bus bar holders 37. According to an exemplary embodiment, the bus bars 36 are constructed from a conductive material such as copper (or copper alloy), aluminum (or aluminum alloy), or other suitable material. According to an exemplary embodiment, the bus bars 36 may be coupled to terminals 38, 39 of the electrochemical cells 24 by welding (e.g., resistance welding) or through the use of fasteners 40 (e.g., a bolt or screw may be received in a hole at an end of the bus bar 36 and screwed into a threaded hole in the terminal 38, 39).

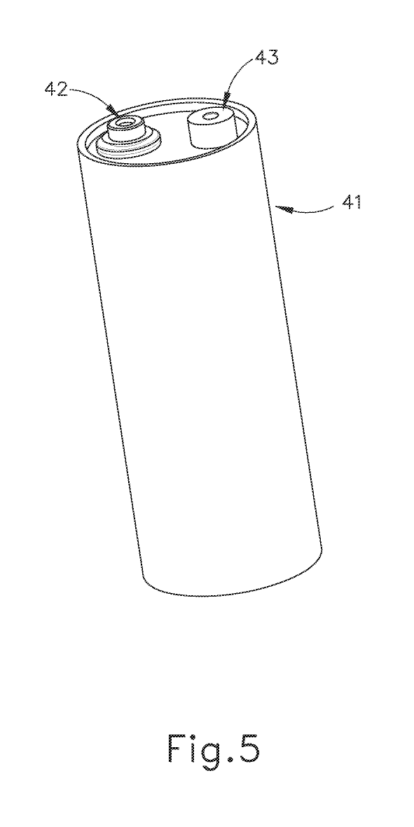

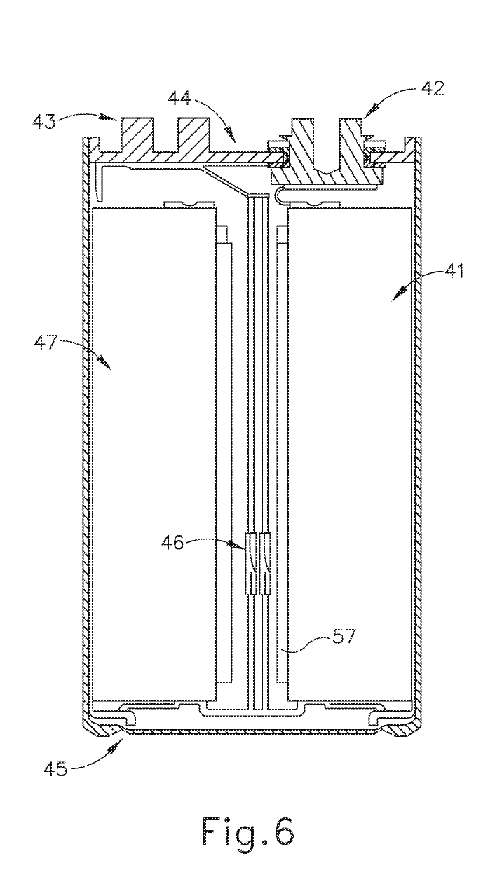

FIG. 5 is a sectional view showing a conventional cylindrical electrochemical cell 24, which has a container or can 41 and two output electrode terminals 42 and 43. Referring now to FIG. 6, a cross-sectional view of an electrochemical cell 24 having a safety device 46 is shown according to an exemplary embodiment. The cell 24 comprises a container or can 41, a vent 45, and output terminals 42 and 43. A gasket 44 insulates the current output terminal 42 electrically from the can 41. The cell 24 also comprises a wound cell element including an electrode assembly 47 that is wrapped around a mandrel 57. The safety device 46 is position inside the mandrel 57. The safety device 46 is configured to interrupt or reduce the amount of electric current passing from the electrode assembly 47 to the output terminal 42 and/or 43 when the temperature inside the can exceeds a predetermined temperature. Preferably, the safety device 46 interrupts or reduces current passing from the electrode assembly 47 to the output terminal 42 and/or 43 in response to temperature change, preferably only to temperature change, and preferably, not in response to a change in pressure. Preferably, the safety device can reduce the flow of electric current passing from the electrode assembly 47 to the output terminal 42 and/or 43 by at least 20%, and preferably at least 50%, and more preferably by at least 85%. The safety device 46 can be a temperature or thermal fuse, several thermal fuses connected in parallel, a bimetal thermostat, or a shunt style bimetallic thermal temperature regulating or limiting device. A traditional current interrupt device (CID) is a pressure active device, including a first conductive component and a second conductive component in electrical communication with each other, wherein electrical communication between the first and second conductive components is interrupted when a gauge pressure increases some value. A traditional CID may be connected with the cell vent 45, and displaces the vent when an increase in gauge pressure within the can 41, beyond a predetermined amount, occurs. In the present embodiment, the safety device 46 is responsive to a temperature change within the can 41, and is disposed inside the can 41, preferably within the mandrel 57, which allows for a more accurate response to conditions within the cell 24. Preferably, a seal, such as the mandrel 57, surrounds the safety device 46 preventing entry of electrolyte onto the safety device 46.

Preferably, wherein the safety device 46 is configured to reconnect, or automatically reset, and allow the flow of electric current from the electrode assembly 47 to the output terminal 42 and/or 43 to resume when the temperature inside the can 41 drops to at or below a predetermined temperature. In one embodiment, the safety device 46 is a thermal fuse is configured to interrupt the flow of electric current from the electrode assembly 47 to the output terminal 42 and/or 43 only when the temperature inside the can 41 exceeds a predetermined temperature. In one embodiment, due to a temperature gradient inside the cell 24, the predetermined temperature is determined by the position of the safety device 46. Depending upon the position of the safety device 46, the predetermined temperature shall set to proper value to prevent the cell 24 from overheating. Preferably, the predetermined temperature is from 100° C. to 200° C., and more preferably from 120° C. to 160° C.

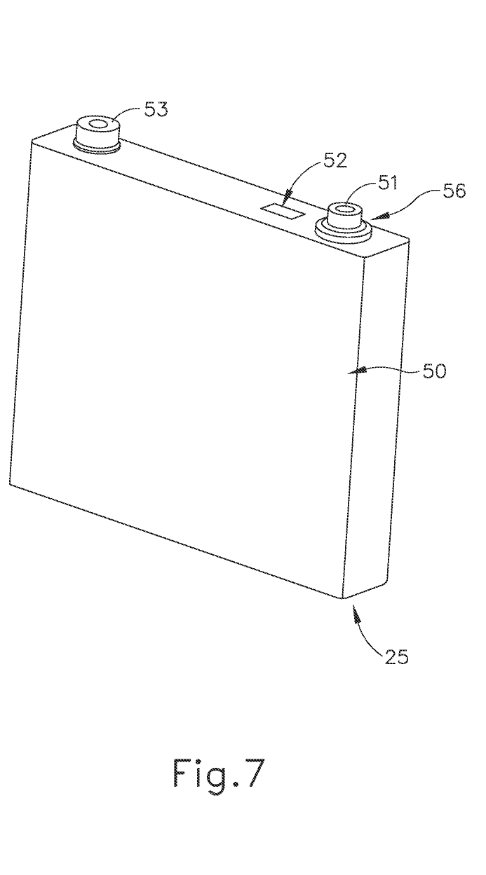

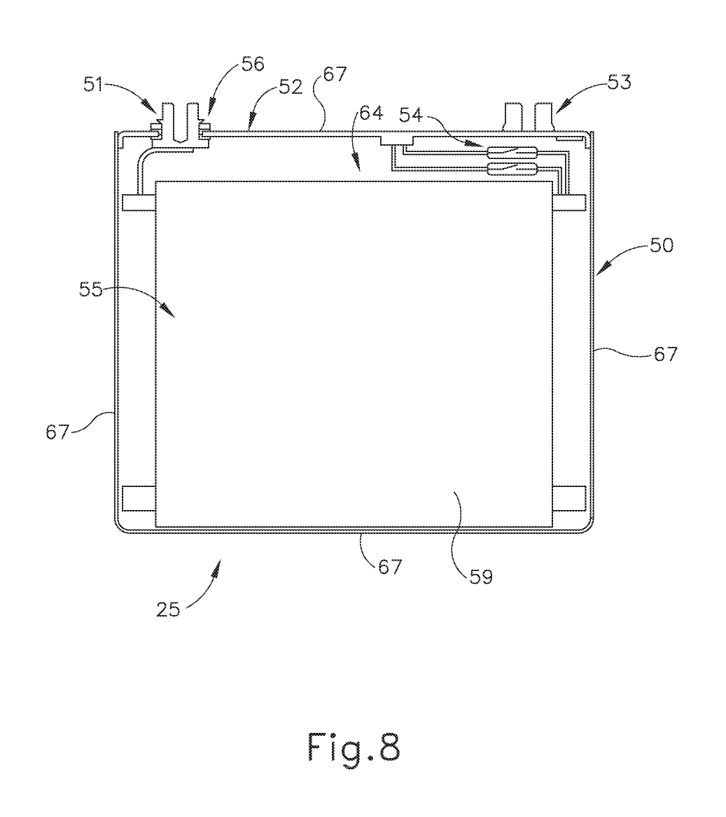

According to an exemplary embodiment, FIG. 7 illustrates a sectional view showing an electrochemical cell 25, which has a container or can 50, two electrode terminals 51 and 53, and a vent 52. The gasket 56 insulates the current output terminal 51 electrically from cell can 50. Referring now to FIG. 8, a cross-sectional view of the electrochemical cell 25 is shown according to an exemplary embodiment. The cell 25 also includes an electrode assembly 55, shown in cross-section, comprising a series of prismatic electrode plates 59. The cell 25 includes a safety device 54 positioned inside the can 50. The safety device 54 is configured to interrupt or reduce the amount of electrical current passing through the electrode assembly 55 and output terminal 51 and/or 53 when the temperature inside the can exceeds a predetermined temperature. The safety device 54 can be a thermal fuse or several parallel thermal fuses, or bimetal thermostat several parallel bimetal thermostats. Parallel connecting several thermal devices may be used to increase the amount of pass through current. The safety device 54 is connected with the electrode assembly 55 and the output terminal 51 and/or 53 and is able to interrupt current generated by the electrode assembly 55 and travelling from the electrode assembly 55 to the output terminal 51 and/or 53 when the temperature within the can 50 exceeds a predetermined temperature. In one embodiment, the safety device 54 is located within a space 64 formed within the can 50, preferably between the electrode assembly 55 and an outer wall 67 of the can 50.

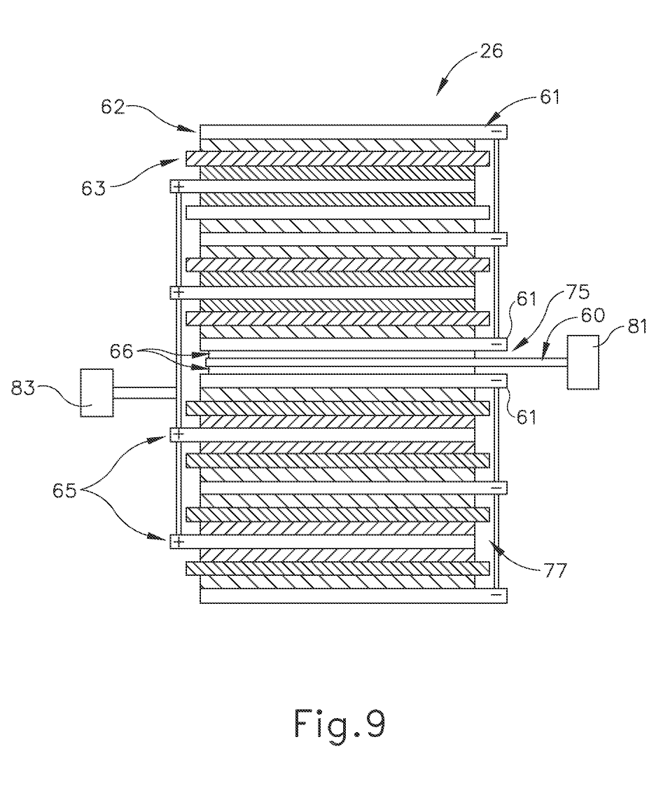

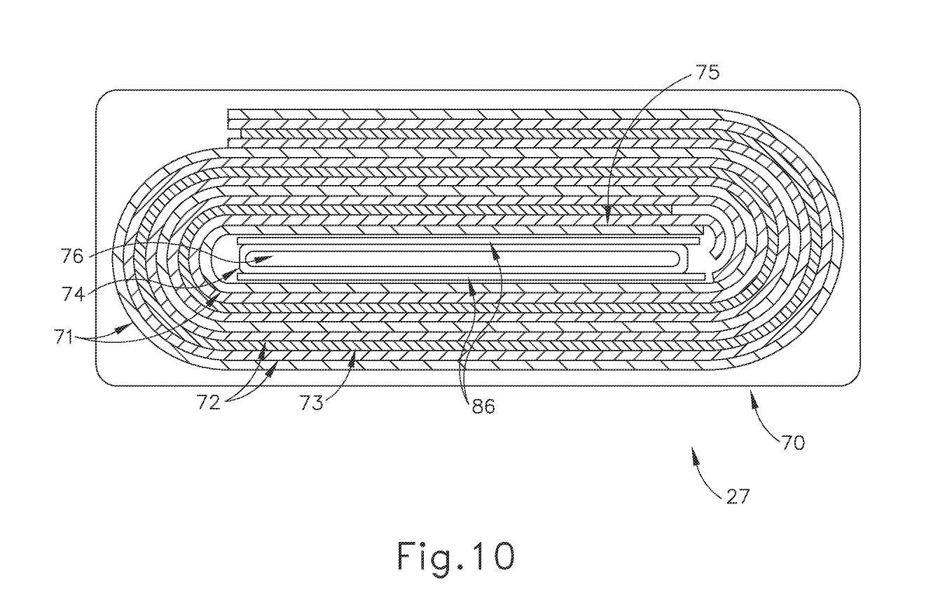

With reference to FIGS. 9 and 10, an electrochemical cell 26 or 27 having a safety device 75 including a layer or a plurality of layers of positive thermal coefficient (PTC) material, or PTC layer 66 or 86 is provided. The PTC layer 66 or 86 material experiences an increase in electrical resistance when the temperature of the PTC layer 66 or 86 is raised. The PTC layer 66 or 86 material is selected such that if the temperature exceeds a predetermined temperature, the amount of electrical current to pass through the PTC layer 66 or 86 is substantially reduced, and preferably no more than 20%, and no more than 10%, and most preferably, no more than 5% the amount of current which may typically pass through and be supplied by the cell 26 or 27. Additionally, the PTC layer 66 or 86 is positioned within the cell 26 or 27 such that it is able to interrupt or reduce the amount of electrical current passing from an electrode assembly within the cell 26 or 27 to an output terminal of the cell 26 or 27, when the temperature inside the cell 26 or 27 exceeds a predetermined temperature.

The electrochemical cell 26 or 27 includes an electrode assembly comprising a negative electrode substrate and a positive electrode substrate, each of which are electrically connected with a negative electrode output terminal and a positive electrode output terminal, respectively. Preferably, the PTC layer 66 or 86 is positioned between and in electrical communication with the negative electrode substrate and the negative electrode output terminal, or the positive electrode substrate and the positive electrode output terminal. Therefore, electrical current stored in the electrochemical cell 26 or 27 must pass through the PTC layer 66 or 86 in order to reach the negative electrode output terminal or the positive electrode output terminal. As a result of this configuration, the PTC layer 66 or 86 is able to interrupt electrical current flowing from the electrode assembly to an output terminal of the cell 26 or 27. The PTC layer 66 or 86 is selected and/or sized so that electrical current passing through it from either the negative electrode substrate or the positive electrode substrate cannot be higher than a predetermined amount. Suitable materials to be used for PTC layer 66 or 86 are any PTC materials known in the art, such as metal particle or carbon black filled conductive polymer-composites. Generally, suitable PTC materials are those that, when exposed to an electrical current in excess of a design threshold, its electrical conductivity decreases with increasing temperature by several orders of magnitude (e.g., 104 to 106 or more). U.S. Pat. Nos. 4,237,441; 4,388,607; 4,534,889; and 7,309,849 provide an explanation of how PTC materials work and are incorporated herein by reference. Once the temperature falls below the predetermined level, electrical current within the cell 26 or 27 is reduced below a suitable threshold, or predetermined amount, in general, and the PTC material substantially returns to its initial electrical resistivity. In the present invention, in order to increase the amount of current which may pass through the PTC layer 66 or 86, the PTC layer 66 or 86 is sized so as to have as large of a contact area as possible through which current flows between when going from the electrode assembly to an output terminal. In one embodiment, the PTC layer 66 or 86 is provided with a large contact area by disposing the PTC layer 66 or 86 between electrode substrates of cell 26 or by wrapping the PTC layer around a mandrel positioned in cell 27. By positioning the PTC layer 66 or 86 in the cell 26 or 27 as such, any resistivity change within the PTC layer 66 or 86 is mainly as a result of an increase or decrease in temperature within the cell 26 or 27, and less so from any self-current heating. In the design, PTC layers 66 or 86 are sheets with large area (e.g. 60 mm×120 mm or more) but thin thickness (e.g. 0.05 mm to 0.1 mm). Per the design, the current will go across a large area but through a short distance. So the resistance of the PTC layers are minimized. Consequently, the self-current heating is minimized.

FIG. 9 is a sectional view showing a stacked type cell 26 having a safety device 75 comprising a PTC layer 66, in accordance with one embodiment. The stacked type cell 26, positive electrode substrates 65 with positive electrode coating 62, and separators 63 interposed there between. Preferably, a plurality of PTC layers 66 sandwich a bare substrate 60, which serves as the negative electrode output terminal and is connected with a negative electrode or current output terminal 81. Preferably, the PTC layers 66 are themselves sandwiched between two bare surface negative substrates 61, as shown in FIG. 9. Thus, any resulting current density passing through the PTC layers 66 will be lower. As mentioned earlier, the PTC layers have large surface area, so the current density will be lower in this case.

Preferably, the PTC layers 66 are positioned centrally within the cell 26, as shown in FIG. 9. By placing the PTC layers 66 in between and in electrical communication with either the negative electrode substrate 61 and the negative electrode output terminal 81 of the cell 26, or the positive electrode substrate 65 and the positive electrode output terminal 83 of the cell 26, electrical current stored within the cell 26 can be prevented from leaving the cell 26, if the temperature of the cell 26 exceeds a predetermined amount. Additionally, by placing PTC layers 66 in a centralized location within the cell 26, such as around the bare substrate 60, any substantial change in resistivity (i.e. an increase in resistivity which is greater than 10% and preferably 20% of a present resistivity value) within the PTC layers 66 will mainly result from a change in temperature within the cell 26. The cell center has the highest temperature within the cell 26. And the PTC layers 66 have minimized resistance and small self-current heating. So the substantial resistivity change will mainly result from the cell temperature change. Thus cell 26 is able to have a safety device 75 which not only prevents electrical current from leaving the cell 26 if the temperature of the cell 26 exceeds a predetermined amount, but also provides a large current output (e.g. 50A continues current output) [PLEASE DEFINE], when needed.

FIG. 10 illustrates an example of a prismatic cell 27 having electrodes 71 and 73 wound around a central core or mandrel 76 and having a PTC layer 86, in accordance with one embodiment of this invention. Preferably, a laminated body is formed by piling a lamellar negative electrode 71, a separator 72, and a lamellar positive electrode 73 and then wrapping the laminated body around the mandrel 76. The prismatic cell 27 includes a can 70 placed at the most outer circumferential portion of the cell 27. Preferably, a metal sheet 74 is connected with a negative electrode output terminal of the cell 27 and is wrapped around a relatively flat mandrel 76. Preferably, at least one, and preferably a plurality of, PTC layers 86 are positioned between the metal sheet 74 and negative electrode 71.

In one embodiment, the metal sheet 74 is connected with a positive electrode output terminal of the cell 27 and is wrapped around a relatively flat mandrel 76. Preferably, at least one, and preferably a plurality of, PTC layers 86 are positioned between the metal sheet 74 and positive electrode 73.

By placing PTC layers 86 in between and in electrical communication with either a negative electrode 71 and a negative electrode output terminal of the cell 27 or a positive electrode 73 and a positive electrode output terminal of the cell 27, electrical current stored within the cell 27 can be prevented from leaving the cell 27 if the temperature of the cell 27 exceeds a predetermined amount. Additionally, by placing the PTC layer 86 in a centralized location within the cell 27, such as around the mandrel 76, any large change in resistivity within the PTC layer 86 will mainly result from a change in temperature within the cell 27, and not from any passing current. Thus cell 27 is able to have a safety device 75 which not only prevents electrical current from leaving the cell 27 if the temperature of the cell 27 exceeds a predetermined amount, but also provides a large current output (e.g. 50A continues current output), when needed.

It should be noted that those skilled in the art will readily recognize that alternative cell configurations may be utilized. For example, the cell may be a prismatic cell having either a wound cell element or prismatic electrode plates. Further, the capacity, size, design, and other features of the electrochemical cell may also vary depending on the specific requirements of the application.

Those skilled in the art will readily recognize that the features disclosed in the embodiments described above may also be incorporated with different electrochemical cell configurations. For example, the features may be applied to electrochemical cells having different configurations or chemistry and/or cells used individually or as part of a larger system (e.g., within a battery system such as shown in FIGS. 1-4).

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the electrochemical cell having a safety device as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

1. An electrochemical cell comprising:
a can;
an output terminal for outputting current generated within the can;
an electrode assembly connected with the output terminal and which comprises a positive electrode and a negative electrode;
electrolyte within the can; and
a safety device provided within the can, wherein the safety device is configured to interrupt or reduce electric current passing from the electrode assembly to the output terminal when temperature inside the can exceeds a predetermined temperature.

2. The electrochemical cell of claim 1 wherein the can is cylindrical.

3. The electrochemical cell of claim 1 wherein the can is prismatic.

4. The electrochemical cell of claim 1, wherein the positive electrode and the negative electrode are wound around a mandrel, and wherein the safety device is provided within the mandrel.

5. The electrochemical cell of claim 1, wherein the safety device is configured to reconnect and allow electric current to pass from the electrode assembly to the output terminal when the temperature inside the can drops to at or below the predetermined temperature.

6. The electrochemical cell of claim 1, wherein the safety device interrupts electric current passing from the electrode assembly to the output terminal in response to temperature change and not in response to a change in pressure.

7. The electrochemical cell of claim 1 further comprising a seal surrounding the safety device preventing the entry of electrolyte onto the safety device.

8. The electrochemical cell of claim 1, wherein the safety device is a shunt style bimetallic thermal temperature regulating or limiting device.

9. The electrochemical cell of claim 8, wherein the safety device automatically resets to allow the flow of electric current from the electrode assembly to the output terminal when the temperature inside the can is at or below the predetermined temperature.

10. The electrochemical cell of claim 1, wherein the safety device is a thermal fuse, and wherein the thermal fuse is configured to interrupt the flow of electric current from the electrode assembly to the output terminal only when the temperature inside the can exceeds the predetermined temperature.

11. The electrochemical cell of claim 10, wherein the predetermined temperature is from 120° C. to 160° C.

12. The electrochemical cell of claim 10, wherein the thermal fuse includes several thermal fuses connected in parallel.

13. The electrochemical cell of claim 10, wherein the safety device includes a layer of positive temperature coefficient (PTC) material.

14. The electrochemical cell of claim 13, wherein the layer of PTC material is positioned in between and in electrical communication with the electrode assembly and the output terminal.

15. A standby power unit comprising the electrochemical cell of claim 1, wherein the standby power unit provides power which may be used as a substitute for power provided from an electrical grid.

16. A method for controlling heat within an electrochemical cell, the electrochemical cell having a can, an output terminal for outputting current generated within the can, an electrode assembly connected with the output terminal and which comprises a positive electrode and a negative electrode, electrolyte within the can, and a safety device provided within the can, the method comprises:
interrupting or reducing the amount of electric current passing from the electrode assembly to the output terminal using the safety device, when temperature inside the can exceeds a predetermined temperature.

17. The method of claim 16 wherein the can is cylindrical.

18. The method of claim 16 wherein the can is prismatic.

19. The method of claim 16, wherein the positive electrode and the negative electrode are wound around a mandrel, and wherein the safety device is provided within the mandrel.

20. The method of claim 16, further comprising reconnecting the safety device to allow electric current to pass from the electrode assembly to the output terminal when the temperature inside the can drops to at or below the predetermined temperature.

21. The method of claim 16, wherein the interrupting or reducing of the amount of electric current is in response to temperature change and not in response to a change in pressure.

22. The method of claim 16, wherein the safety device is a shunt style bimetallic thermal temperature regulating or limiting device.

23. The method of claim 16, wherein the safety device is a layer of positive temperature coefficient (PTC) material.

24. The method of claim 23, wherein the layer of PTC material is positioned in between and in electrical communication with the electrode assembly and the output terminal.

25. A battery system comprising:
a plurality of electrochemical cells, wherein each electrochemical cell includes a can, an output terminal for outputting current generated within the can, an electrode assembly connected with the output terminal and which comprises a positive electrode and a negative electrode, electrolyte within the can, and a safety device provided within the can, wherein the safety device is positioned between and electrically connected with the electrode assembly and the output terminal, and wherein the safety device is configured to interrupt or reduce the amount of electric current passing from the electrode assembly to the output terminal when temperature inside the can exceeds a predetermined temperature.

26. The electrochemical cell of claim 25 wherein the can is cylindrical.

27. The electrochemical cell of claim 25 wherein the can is prismatic.

28. An xEV vehicle comprising the battery system of claim 25, wherein the battery system provides all or a portion of the motive power for the vehicle.

29. The battery system of claim 25, wherein the positive electrode and the negative electrode are wound around a mandrel, and wherein the safety device is provided within the mandrel.

30. The battery system of claim 25, wherein the safety device is configured to reconnect and allow electric current to pass from the electrode assembly to the output terminal when the temperature inside the can drops to at or below the predetermined temperature.

31. The battery system of claim 25, wherein the safety device interrupts electric current passing from the electrode assembly to the output terminal in response to temperature change and not in response to a change in pressure.

32. The battery system of claim 25 further comprising a seal surrounding the safety device preventing the entry of electrolyte onto the safety device.

33. The battery system of claim 25, wherein the safety device is a shunt style bimetallic thermal temperature regulating or limiting device.

34. The battery system of claim 25, wherein the safety device is a layer of positive temperature coefficient (PTC) material.

35. The battery system of claim 34, wherein the layer of PTC material is positioned in between and in electrical communication with the electrode assembly and the output terminal.
